(19) United States
(12) Patent Application Publication
(10) Pub. No.: US 2005/0032981 A1
(43) Pub. Date: Feb. 10, 2005

(54) Thermoplastic vulcaninates for run-flat tires

(76) Inventors: Thomas Chen-Chi Yu, Bellaire, TX (US); P.J. Buriak, Cypress, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/498,690

(22) PCT Filed: Dec. 12, 2002
(86) PCT No.: PCT/US02/39797

Related U.S. Application Data
(60) Provisional application No. 60/341,460, filed on Dec. 13, 2001.

(51) Int. Cl. C08F 8/00

(52) U.S. Cl. 525/191

(57) ABSTRACT

This invention relates generally to run-flat tires. More specifically, this invention relates to compounds comprising thermoplastic vulcanizates that are suitable for use in run-flat tire inserts.

### FIELD

This invention relates generally to run-flat tires. More specifically, this invention relates to compounds comprising thermoplastic vulcanizates that are suitable for use in run-flat tire inserts.

### BACKGROUND

The thermoplastic vulcanizate compositions of this invention can be used in the production of a run-flat tire insert. Such run flat tires are very well known in the art and are characterized by their ability to be used for some period of time in a deflated condition. In one design, this run-flat ability is created by the use of one or more fillers or “inserts” which stiffen the sidewalls and permit the tire to be driven while uninflated as is described in U.S. Pat. Nos. 5,368,082, 6,263,935, and 5,871,600 (each fully incorporated herein by reference). In a preferred embodiment the thermoplastic vulcanizates of this invention are used in the production of such “fillers” or “inserts” one or more of which are in turn used as structural components in a pneumatic tire. These inserts may be disposed on the wheel inner rim between the tire bead flanges and extend radially outward from the wheel axis of rotation to support the tire in a deflated condition as described in U.S. Pat. No. 6,109,319. There are numerous methods of incorporating such inserts into the tire including, but not limited to, those described in the patents cited above as well as in U.S. Pat. Nos. 4,193,437, 4,405,007, 5,639,320, 5,427,166, 5,868,190, 4,779,658, 4,917,164, 5,427,176, 5,529,105, 5,494,958, 6,022,434, 5,238,040, 5,368,082, 5,427,166, 5,511,599, 4,067,372, 4,287,924, 5,164,029, 5,217,549, 5,361,821, 4,067,374, 5,309,970, 5,263,526, 5,439,041, 5,5385,800 5,526,862, and 6,182,728 (describes “wedges” rather than inserts), U.S. Application No. 2001/0001971 A1 and WO 01/42000 A1, EP 385,192, and EP 385,192 (each fully incorporated herein by reference for their various descriptions of “insert,” “filler,” “wedge” design.) Despite decades of research, hundreds of publications, and millions of dollars devoted to this highly valuable technology, there still has yet to be developed an economically produced run-flat tire that actually meets the needs of the general population.

The present invention describes new compositions which, when incorporated into tire construction, provide improved run-flat capability as well as recycleability in some embodiments. These compositions comprise one or more thermoplastic vulcanizates. Thermoplastic vulcanizates are well known compounds that have been used in a variety of applications but never before in run-flat tire inserts.

### SUMMARY

This invention is directed to a run-flat tire comprising a thermoplastic vulcanizate. In an embodiment, the invention is directed to a run-flat tire or insert comprising a thermoplastic vulcanizate having a propylene polymer matrix phase and an ethylene based copolymer rubber phase. In another embodiment this invention is directed to a run-flat tire or insert comprising a thermoplastic vulcanizate having a polyamide polymer matrix phase and ethylene based copolymer rubber phase. In another embodiment, the rubber phase further comprises a halogenated copolymer of isomonoolefin and alkylstyrene. In another embodiment, the rubber phase further comprises either a high crystallinity or low crystallinity ethylene-propylene-diene terpolymer.

### BRIEF DESCRIPTION OF THE DRAWINGS

FIG. 1 shows DSC traces of an embodiment of a thermoplastic vulcanizate of this invention, which illustrate that by substituting a low crystallinity ethylene-propylene-diene terpolymer for at least a portion of the rubber phase, the low temperature melting peak can be reduced.

### DETAILED DESCRIPTION

A thermoplastic vulcanizate (TPV) is generally known to be a reprocessable material that has at least one partially or fully crosslinked rubbery component dispersed in a thermoplastic matrix. A thermoplastic vulcanizate possesses the properties of a thermoset elastomer and is reprocessable in an internal mixer. Upon reaching temperatures above the softening point or melting point of the matrix phase a TPV can form continuous sheets and/or molded articles with complete knitting or fusion of the thermoplastic vulcanizate under conventional molding or shaping conditions for thermoplastics.

Generally, thermoplastic vulcanizates are prepared by blending the materials for the matrix and rubber phases along with desired additives and a cure package to promote at least partial crosslinking of the rubber phase.

The most suitable thermoplastic vulcanizates for run-flat tires are those that can withstand temperatures of at least 120° C. and provide the absorption necessary to reduce strikethrough and wear on the deflated tire during operation.

Matrix Phase

The matrix phase portion of the thermoplastic vulcanizate may comprise any thermoplastic, including but not limited to polyolefins, polyamides such as nylon, or polyester. Suitable polymers for the matrix phase are those thermoplastic polymers made by the polymerization of monoolefin monomers using a high pressure, low pressure or intermediate pressure process with Ziegler Natta and/or metallocene catalysts. Preferably the monoolefin monomers converted to repeat units are at least 95 wt % monoolefins of the formula CH₂═C(CH₃)—R or CH₂═CHR where R is a H or a linear or branched alkyl group of from 1 to 12 carbon atoms.

Suitable polyolefins are polyethylene and polypropylene or their copolymers and mixtures thereof. The polyethylene can be high density or low density. The polypropylene can be a homopolymer or copolymer or mixtures thereof. Generally, the higher the melting temperature of the plastic phase the higher the potential use temperature of the thermoplastic vulcanizate.

Preferably, the matrix phase is based on a propylene polymer. This propylene polymer component can be any propylene-based polymer, i.e., a polymer wherein a majority of units are derived from propylene. Thus propylene homopolymers, copolymers and impact copolymers may be suitable. A preferred propylene polymer is exemplified by ExxonMobil Chemical's Escorene™ PP 1105 which is a homopolymer having a melt flow rate (MFR) of 35, a flexural modulus of 1300 MPa. Generally, the propylene polymer should have a MFR of 15 or higher. The polypropylene polymer can be made using single-site or multiple-site catalysts. In some embodiments, metallocene or other single-site catalysts are preferred.

The impact modified polypropylenes suitable for the matrix phase is itself a blend of a propylene polymer matrix with an uncrosslinked elastomer rubber dispersed therein. Preferably the elastomer is a copolymer and the elastomer content is less than 20 wt % of the impact modified polypropylene blend. The propylene polymer constituent of the impact modified polypropylene is preferably a homopolymer of propylene having a propylene content of at least 95 wt % and a weight average molecular weight of at least 70,000. Preferably, the propylene polymer is highly stereoregular, either isotactic or syndiotactic regularity, with isotactic regularity being preferred.

The impact modified polypropylene may be prepared as a reactor blend wherein the isotactic propylene polymer and elastomer portion are simultaneously formed by polymerization of propylene with another appropriate olefin comonomer in different zones or in a single reaction zone as is known in the art. Alternatively, the impact modified polypropylene may be formed by melt compounding of a propylene homopolymer with an elastomer, each of which were separately formed prior to blending. Generally, for reasons of economy, impact modified polypropylenes are prepared as reactor blends and for this reason generally have an impact modifying elastomer content not exceeding about 20 wt % of the reactor blend, and more typically not exceeding about 12 wt % of the reactor blend. Further discussion of the particulars of an impact modified polypropylene may be found in U.S. Pat. No. 4,521,566. However the impact modified polypropylene is formed, it generally comprises from about 80 wt % to about 90 wt % of a propylene polymer and from about 10 wt % to about 20 wt % of an elastomer such that the propylene content of the blend is at least about 80 wt %. The impact modified polypropylene has a 1% secant modulus of from about 60,000 psi to about 130,000 psi, and a MFR of from about 0.5 to about 5.0 and preferably from about 0.5 to about 3.

Thermoplastic polyamide compositions may also be used to form the matrix for the thermoplastic vulcanizates of this invention. These generally comprise crystalline or resinous, high molecular weight solid polymers including copolymers and terpolymers having recurring polyamide units within the polymer chain. Polyamides may be prepared by polymerization of one or more epsilon lactams such as caprolactam, pyrrolidone, lauryllactam and aminoundecanoic lactam, or amino acid, or by condensation of dibasic acids and diamines. Both fiber forming and molding grade nylons are suitable. Examples of such polyamides are polycaprolactam (nylon 6), polylaurylactam (nylon 12), polyhexamethyleneadipamide (nylon 6,6), polyhexamethylene-azelamide (nylon 6,9), polyhexamethylenesebacamide (nylon 6,10), polyhexamethyleneisophthalamide (nylon 6,IP) and the condensation product of 11-aminoundecanoic acid (nylon 11); as well as partially aromatic polyamides made by polycondensation of meta xylene diamine and adipic acid. Furthermore, the polyamides may be reinforced, for example, by glass fibers or mineral fillers or mixtures thereof. Pigments, such as carbon black or iron oxide may also be added. Additional examples of polyamides are described in Kirk-Othmer, Encyclopedia of Chemical Technology, v. 10, page 919, and Encyclopedia of Polymer Science and Technology, Vol. 10, pages 392-414. Commercially available thermoplastic polyamides may be advantageously used in the practice of this invention, especially those having a softening point or melting point between 160° C. to 275° C.

The matrix phase of the thermoplastic vulcanizate is from about 15 to about 80 parts by weight, more preferably from about 25 to about 75 parts by weight, and preferably from about 25 to about 50 parts by weight per 100 parts of the blend of thermoplastic plastic and the rubber phase in the thermoplastic vulcanizate. The rubber is preferably from about 20 to about 85 parts by weight, more preferably from about 25 to about 75 parts by weight and preferably from about 50 to about 75 parts by weight per 100 parts by weight of said blend in the thermoplastic vulcanizate. If the amount of plastic is based on the amount of rubber, it is preferably from about 15 to about 400 parts by weight, more preferably from about 30 to about 350 parts and preferably from about 35 to about 300 parts by weight per 100 parts by weight of the rubber. Preferably, the final thermoplastic vulcanizates of this invention will, on a total olefin monomer content basis, contain from about 37 to about 51 weight % propylene units; from about 41 to about 52.5 weight % ethylene units; from about zero to about 0.5 weight % diene units; and the balance will be from about 8 to about 10 weight % of units derived from a C₄ to C₈ alpha-olefin.

In a preferred embodiment, the proportion of impact modified polypropylene resin component making up the matrix to the elastomer component making up the rubber phase provides the resulting thermoplastic vulcanizate composition with a 1% secant modulus of 50,000 psi or less, preferably 40,000 psi or less, and most preferably 30,000 psi or less.

Rubber Phase

The rubber phase can be based on any rubber having residual unsaturation or curable functional sites that can react and be at least partially crosslinked with curing agents. Suitable materials for the rubber thus include halobutyl rubber, EP and EPDM rubbers, natural rubber, synthetic rubbers such as synthetic polyisoprene, polybutadiene rubber, styrene-butadiene rubber, butadiene-acrylonitrile rubber etc. Amine functionalized or epoxy functionalized synthetic rubbers may be used. Examples of these include amine functionalized EPDM, and epoxy functionalized natural rubber and functionalized metallocene plastomer. These materials are commercially available.

In preferred embodiments, the rubber phase is based on an ethylene copolymer, i.e., ethylene derived units are the major constituent by weight or mole %. Most preferred are those having a density of from about 0.915 g/cm³ to about 0.860 g/cm³ that are prepared with a single sited catalyst, for example, a catalyst the transition metal components of which is an organometallic compound at least one ligand of which has a cyclopentadienyl anion structure through which such ligand coordinates to the transition metal cation. Such a catalyst system, now commonly known as “metallocene” catalyst, produces ethylene copolymers in which the comonomer is more randomly distributed within a molecular chain and also more uniformly distributed across the different molecular weight fractions comprising the copolymer than has heretofore generally been possible to obtain with traditional types of heterogeneous multi-sited Ziegler-Natta catalysts. Metallocene catalysts are further described in U.S. Pat. Nos. 5,017,714 and 5,324,820.

These preferred ethylene copolymers are neither totally thermoplastic-like nor elastomer-like but are partially like a thermoplastic and partially like an elastomer, sometimes referred to as a “plastomer”. Ethylene derived units will generally make up from about 85 mole % to about 96 mole % of the these preferred ethylene copolymers; the alpha-olefin comonomer content comprises from about 15 to about 3.5 mole % of the copolymer and is incorporated into the copolymer in an amount that provides for a density of from about 0.915 g/cm³ up to a density of about 0.860 g/cm³. The distribution of the alpha-olefin comonomer within the preferred copolymers is substantially random and also uniform among the differing molecular weight fractions that comprise the ethylene copolymer. This uniformity of comonomer distribution within the copolymer, when expressed as a comonomer distribution breadth index value (CDBI), provides for a CDBI greater than 60, preferably greater than 80, and more preferably greater than 90. Further, these preferred ethylene copolymers are characterized by a DSC melting point curve that exhibits the occurrence of a single melting point peak occurring in the region of 40° C. to 110° C. (second melt rundown), and the copolymer preferably has a weight average molecular value no less than 70,000 and no greater than 130,000, and the a molecular weight distribution (Mw/Mn) value of less than or equal to 4.0 and preferably less than or equal to 3.5. Further, these preferred copolymers have a 1% secant modulus not exceeding about 15,000 and as low as about 800 psi or even less.

The EXACT™ elastomers are available from ExxonMobil Chemical. These plastomers are a copolymer of ethylene with a C₄-C₈ alpha-olefin comonomer and have a plastic-like molecular weight. This invention, however, can also be practiced using Engage™ polymers, a line of metallocene catalyzed plastomers available from Dow Chemical Company of Midland, Mich.

The comonomer of the plastomer is preferably an acyclic monoolefin such as butene-1, pentene-1, hexene-1, octene-1, or 4-methyl-pentene-1. In some respects, it is desirable for the plastomer to be an ethylene-alpha-olefin-diene terpolymer since incorporation of a quantity of diene monomer into the plastomer provides the plastomer with further residual unsaturation to allow further functionalization and/or cross-linking reactions or coupling of the plastomers in the finished run-flat compound. In the case of a non-diene containing plastomer the residual or chain end unsaturation, on the basis of the quantity of terminal double bonds per 1,000 carbon atoms, would be of the vinyl type 0.05 to 0.12, of the trans-vinylene type 0.06 to 0.15, and of the vinylene type 0.05 to 0.12.

Thus in a first preferred embodiment, this invention is directed to a run-flat tire insert comprising a thermoplastic vulcanizate having a propylene homopolymer or impact copolymer matrix phase and an ethylene based copolymer rubber phase as described in detail above. In a second preferred embodiment, this invention is directed to a run-flat insert comprising a thermoplastic vulcanizate having a polyamide polymer (e.g., nylon) matrix phase, and an ethylene based copolymer rubber phase as described in detail above.

In another embodiment, the TPV comprises a polypropylene homopolymer or impact copolymer matrix phase and a rubber phase that comprises two or more rubbers. Preferably the rubber phase of this embodiment comprises (A) an ethylene copolymer rubber phase having a C₄-8 alpha-olefin comonomer, having a plastic-like molecular weight, as described above (such as the EXACT™ elastomers), and (B) an ethylene-propylene-diene (EPDM) terpolymer.

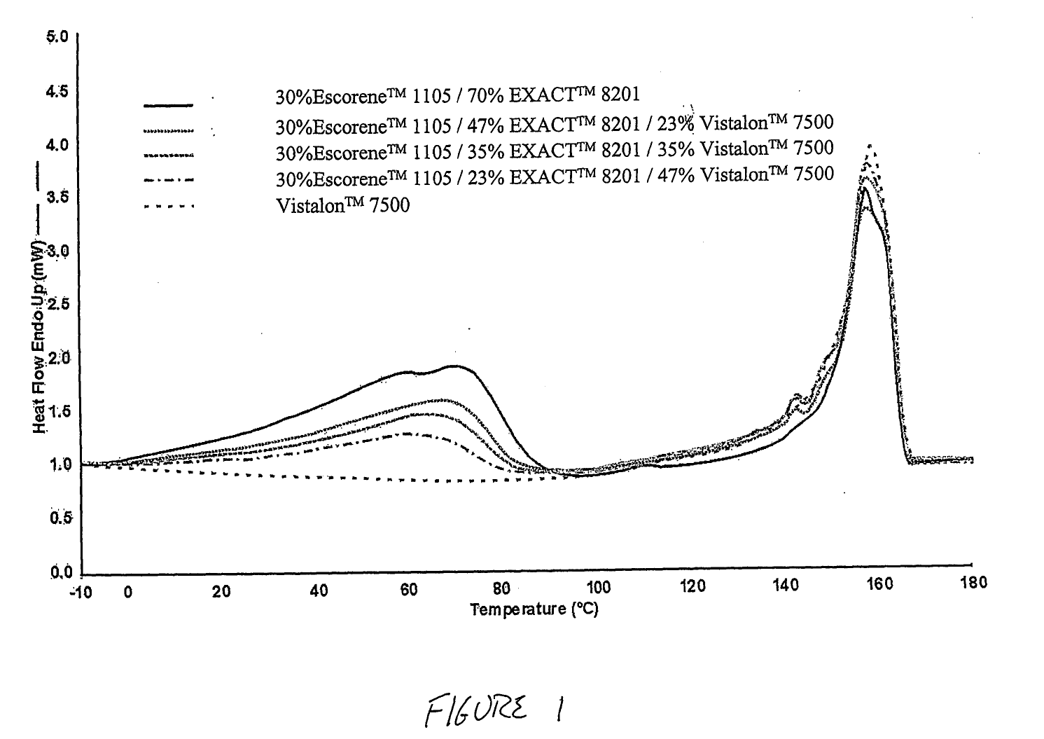

The EPDM of component (B) above may be a low crystallinity EPDM or a high crystallinity EPDM. By low crystallinity EPDM, it is meant that the EPDM has a heat of fusion less than 10 Joules/gram (J/g), as determined by DSC (first melt). A suitable low crystallinity EPDM terpolymer for this embodiment of the invention is Vistalon™ 7500 (sold by ExxonMobil Chemicals), which has an ethylene content of about 52.3 wt % and a heat of fusion of about 0.6 J/g. In some run-flat tire applications, the absence of a low melting peak (as measured by DSC) is desirable, because the run-flat tire is designed to allow the flattened tire to travel at speeds up to 50 miles/hour and at distances up to 90 miles. The prolonged use of the flattened tire travelling at such speeds will cause the tire temperature to increase. It is believed that the presence of a low melting ingredient in the run-flat tire may compromise the tire performance, such a handling, and cause excessive treadwear depending on the specific design. The low melting peak (measured by DSC) can be reduced by substituting a portion of the plastomer rubber component with a low crystallinity EPDM. For example, referring now to FIG. 1, a TPV comprising a polypropylene homopolymer matrix phase (Escorene™ PP 1105), and a rubber phase comprising an ethylene copolymer having a C₄-C₈ alpha-olefin comonomer (Exact™ 8201, ethylene content 72.5 wt % and heat of fusion of 50 J/g) and a low crystallinity EPDM rubber (Vistalon™ 7500) has a reduced low temperature melting peak when compared to the same TPV without the low crystallinity EPDM rubber. For the purposes of this embodiment of the invention, the low crystallinity EPDM component can comprise from about 50 wt % by weight to about 75 wt %, more preferably about 60 wt % to about 70 wt % of the rubber phase. In this regard, the ethylene copolymer of component (A) preferably has a density less than 0.90 g/cm³, and more preferably a density between about 0.860 g/cm³ and 0.880 g/cm³.

In another embodiment, the EPDM of component (B) is a high crystallinity EPDM. It is believed that the addition of a high crystallinity EPDM to the rubber phase of this invention will improve the softness (flexural modulus and hardness) of the TPV. By high crystallinity EPDM, it is meant that that the EPDM has an ethylene content of more than 70 wt % and a heat of fusion more that 10 J/g, as measured by DSC (first melt). Preferably the high crystallinity EPDM component comprises from about 20 wt % to about 60 wt % of the rubber phase, more preferably about 25 wt % to about 50 wt % of the rubber phase. Preferred high crystalline EP rubbers are represented by ExxonMobil Chemical's Vistalon™ products. Most preferred is Vistalon™ 1703P which contains 0.9 wt % vinyl norbornene, and 78% ethylene content.

In another embodiment the rubber phase of the TPV further comprises a halogenated copolymer of isomonoolefin and alkylstyrene as described in U.S. Pat. Nos. 5,162,445 and 6,207,754 (both fully incorporated herein by reference). The thermoplastic vulcanizate compounds of this invention may also include various other components, for example, EP(D)M and EP rubber (EP) so that more processing oil can be added to reduce the stiffness of the final compound, as well as to improve processability and/or performance.

The halogenated copolymer which may be included in the rubber phase is preferably a C₄ to C₇ isomonoolefin and an alkylstyrene. The halogenated copolymer can comprise from about 50 wt % by weight to about 75 wt %, more preferably about 60 wt % to about 70 wt % of the rubber phase. Suitable halogenated copolymers comprise between from about 0.5 to about 50 weight percent, preferably from about 1 to about 20 weight percent, more preferably 2.0 to about 20 weight percent, of the alkylstyrene units. The halogen content of the copolymer may range from above zero to about 7.5 weight percent, preferably from about 0.1 to about 7.5 weight percent.

The Mooney viscosity at 125° C. (ML 1+8) of such halogenated copolymers is typically between from about 20 to about 55, preferably from about 25 to 45, most preferably from about 30 to about 35.

Such halogenated copolymers, as determined by gel permeation chromatography (GPC), have narrow molecular weight distributions and substantially homogeneous compositional distributions, or compositional uniformity. Such copolymers include the alkylstyrene moiety represented by the formula: 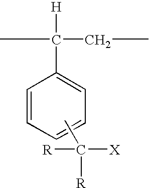
in which each R is independently selected from the group consisting of hydrogen, alkyl preferably having from 1 to 5 carbon atoms, primary haloalkyl having from 1 to 5 carbon atoms, secondary haloalkyl preferably having from 1 to 5 carbon atoms, and mixtures thereof and X is selected from the group consisting of bromine, chlorine and mixtures thereof. The preparation of these polymers are well known as disclosed in U.S. Pat. No. 5,162,445 (fully incorporated herein by reference). Preferably, the isomonoolefin is isobutylene and the alkylstyrene is halogenated methylstyrene wherein the halogen is bromine. The para-isomer is particularly preferred.

The halogenated copolymer for use in this invention may be produced by halogenating an isobutylene-alkylstyrene copolymer using bromine in normal alkane (e.g., hexane or heptane) solution utilizing a bis azo initiator, e.g., AIBN or VAZO 52 (2,21-azobis(2,4 dimethylpentane nitrile)), at about 55° C. to 80° C. for a time period ranging from about 4.5 to about 30 minutes, followed by a caustic quench. The recovered polymer is then washed in basic water wash and water/isopropanol washes, recovered, stabilized and dried. At least about 95 weight percent of the resulting halogenated copolymer for use in this invention has a halogenated alkylstyrene content within about 10 weight percent, and preferably within about 7 weight percent, of the average alkylstyrene content for the overall composition, and preferably at least 97 weight percent of the copolymer product has an alkylstyrene content within about 10 weight percent and preferably about 7 weight percent, of the average alkylstyrene content for the overall composition.

The thermoplastic vulcanizates of this invention may be formed from other components or additives, such as processing oil and moisture generating agent, Epsom salt, primary, secondary antioxidants, and processing aids.

Curing

Curing can be effected by any of the well known curing systems, including sulfur and sulfur donor cure systems, peroxide cure, and quinone type cure systems, and silane coupling agents. There are several methods of crosslinking the rubber phase using chemical agents. One common method involves the use of peroxide, such as dicmyl peroxide, to form carbon to carbon bonds. However, this method is not useful when the matrix phase is based on propylene polymer because the peroxide will simultaneously degrade the polypropylene. Another issue with peroxide crosslinking is the tendency to scorch (premature crosslinking) during processing. An alternate method involves the use of vinylalkoxysilanes, such as vinyltrimethoxy silane (VTMOS) or vinyltrimethoxysilane (VTEOS) in conjunction with a very small peroxide, i.e., a ratio of vinylalkoxysilane/peroxide of from 10/1 to 40/1. VTMOS is preferred because the grafted rubber can be crosslinked rapidly during reactive compounding. By careful selection of low firing peroxide, degradation of polypropylene can be avoided. The peroxide will trigger the grafting reaction of VTMOS onto the plastomer and the grafted VTMOS can subsequently crosslink promoted by a hydrolysis catalyst such as dibutyltin dilaurate, in the presence of moisture.

In a preferred embodiment, the thermoplastic vulcanizate is formed by crosslinking via a specifically formulated silane masterbatch, which contains a built-in moisture generating compounding step. Such a process is disclosed in U.S. Pat. No. 5,112,919, incorporated herein by reference, which provides a process for adding a solid feed of silane crosslinking agent into an extruder, as opposed to liquid silane. The injection of liquid silane typically requires an expansive metering device to ensure an accurate dosage control. Inaccurate dosage control can lead to coating of the extruder screw with silane, which will typically lead to fouling and equipment shut down. The moisture generating agent releases hydrated water upon heating inside the compounding equipment, which enables the crosslinking to occur. Non-limiting examples include adding inorganic salt and clay. Combining a metal oxide and a carboxylic acid during the melt compounding can also be performed to release water into the melt. In some cases, direct injection of a small amount of water into a twin screw extruder can be performed.

Two types of silane masterbatch are commercially available. One type is based on a porous polyethylene carrier, and the other type is based on a porous polypropylene carrier. For thermoplastic vulcanizates having a propylene-based matrix, the preferred carrier is porous polypropylene. More preferably, the polypropylene carrier is a polypropylene homopolymer or a polypropylene impact copolymer. Polypropylene random copolymers are not preferred because the vinylsilane will graft onto the ethylene linkages along the backbone of the polypropylene random copolymer and crosslink both the carrier resin as well as the dispersed rubber particles.

In another embodiment, engineering resins such as polyamide or thermoplastic polyesters are used as carrier resins in order to increase the high temperature resistance of the TPV. Maleic anhydride grafted plastomers or maleic, anhydride grafted EP rubber or EPDM can be used as a compatibilizer between the engineering resin and the rubber phase. Peroxide and vinylsilane can also be used. Therefore, during reactive compounding of nylon TPV or polyester TPV, either a silane masterbatch or a peroxide masterbatch can be used to crosslink the rubber phase.

Run-Flat Tire Insert

A particularly preferred run-flat tire insert construction is based on a three-layer design wherein each layer comprises a thermoplastic vulcanizate of this invention. The outer layer in this embodiment includes ultra high molecular weight polyethylene powders (UHMWPE) with a specific gravity at 23° C. of 0.925 to 0.940 or ground tire treads which confers abrasion resistance. The innermost layer includes a talc additive that provides stiffness, stability and a snug fit on the inner wheel rim. Other mineral fillers or chopped fiberglass can also be used for this purpose.

The middle layer is a foamed thermoplastic vulcanizate. This foam may be prepared by any number of well known techniques, for example, those described in U.S. Pat. No. 5,939,464. Generally, thermoplastic elastomers have been foamed using chemical blowing agents, low-boiling hydrocarbons, or chlorofluorocarbons as foaming agents. These have drawbacks, based on environmental considerations. Although the chlorofluorocarbons have been widely and effectively used in foaming thermoplastic elastomers, their perceived threat to the ozone layer has prompted a search for alternative foaming methods which do not possess environmental hazards or present any of the other drawbacks. Other foaming agents include isobutane, azodicarbonamides, sodium bicarbonate, sodium carbonate, etc. The process for using chemical blowing agents is explained in trade literature from companies such as Ready International Corp. in Keyport, N.J.

It has been found that thermoplastic vulcanizates can be foamed by heating them to above their melting point, admixing with a minor amount of water under pressure, and then releasing the mixture to atmospheric pressure. Excellent foaming can be accomplished with water as the sole foaming agent.

Regardless of how the thermoplastic vulcanizates of this invention are incorporated into the tire structure, run-flat capability is directly dependent on the use of such thermoplastic vulcanizates. Preferably these run-flat tire inserts are capable of providing at least 90 miles of use at 50 MPH without significant tire damage and with safe handling, that is the run-flat tires are capable of withstanding temperatures of at least 120° C. and providing the absorption necessary to reduce strikethrough.

### EXAMPLES

The present invention is illustrated hereinafter in more detail with reference to the following examples, which should not be construed as to limit the scope of the present invention. Table 1 provides a list of the test methods used in the examples.

In the following examples, Escorene™ PP 1105 is a propylene homopolymer having a melt flow rate of 35, a flexural modulus (MPa) of 1300, and a Notched Izod Impact (@23° C. KJ/m²) of 3.2. Escorene™ PP 8191 is an impact modified polypropylene having a density of 0.9 g/cm³, a melt flow rate of 1 dg/min, an ethylene comonomer content of 20 wt %, a 1% secant modulus of 62,500 psi and a DSC peak melting point of 141.6° C. Capron™ CA 73 ZP is a polyamide-6 resin from Honeywell, Morristown, N.J. Ultamid 35 is a polyamide 6,66 copolymer from BASF, Freeport, Tex. Pebax 3533 is a flexible polyamide from Atofina Chemical, Philadelphia, Pa. Sunpar 150 HT is a processing oil from Sun Oil, Marcus Hook, Pa. Exact™ 8201 is an ethylene-octene copolymer having a melt index of 1.1 g/10 min, a density of 0.882 g/cm³, a flexural modulus 1% secant of 3300 psi, a Mooney viscosity (1+4 @125° C.) of 19, a peak melting temperature of 66.7° C., and a melt flow rate of 2.5 g/10 min. Exact™4033 is an ethylene-butene copolymer having a density of 0.880 g/cm³, a melt index of 0.8 dg/10 min., a flexural modulus 1% secant of 3300 psi, a Mooney viscosity (1+4 @125° C.) of 28 and a DSC peak melting point of 60° C. Vistalon™ 1703P is a high crystallinity EPDM containing about 0.9 wt % vinyl norbornene and 78 wt % ethylene. Vistalon™ 3666 is an oil extended low crystalline EPDM with 0 J/g heat of fusion. Vistalon™ 9303H is another low crystalline EPDM having a 3.7 J/g heat of fusion. Exxpro™ 89-1 is a brominated polymer derived from a copolymer of isobutylene and methylstyrene. Exxpro™ 89-1 has a density of 0.93 g/cm³, a Mooney viscosity of 35 ML (1+8) @ 125° C. and a bromine wt % of 1.2.

Escorene™, Exact™, Vistalon™ and Exxpro™ are products available from ExxonMobil Chemical Company. The Silane masterbatch used was supplied by OSi Specialties, Crompton Corporation, Tarrytwon, N.J., under the designation of XL-Pearl Y-15307, which comprises a 70 wt % silane cocktail absorbed into 30 wt % porous polypropylene. The majority of the silane cocktail comprises a VTMOS type of silane with grafting peroxide and hydrolysis catalyst added. A commercial supplier of porous carrier is supplied by Accurel Systems, Akzo Nobel Membrana Gmbh, Obernburg, Germany.

TABLE 1

| | Test Method |
|---|---|
| Melt Flow Rate | ASTM D1238 |
| Shore Hardness | ASTM D2240 |
| Conditioning of Test Specimens | ASTM D618 |
| Tensile Strength | ASTM D638 |
| Tensile Modulus | ASTM D638 |
| Ultimate Elongation | ASTM D638 |
| Flexural Modulus | ASTM D790 |
| DSC Peak Melting Point | ASTM D3417 |
| Gel Content | ASTM D- |
| | 2765 |
| Compression Set | ASTM D-395 |

### Example 1

In Samples 1 through 5, various amounts of silane masterbatch (from 1.5 parts per hundred to 3.5 parts per hundred resin) were added to 30/0 blends of Escorene™ PP 1105/Exact™ 8201 and the mixture melt mixed in a 0° C. size Banbury mixer to perform a silane grafting reaction. A batch weight of 2270 grams was used. After the silane grafting reaction was completed, as indicated by a motor torque increase, the feed ram was raised, and 0.2 parts of Epsom salt per hundred parts of resin was added. The ram was then lowered until another torque increase was observed. In order to prevent the material from being heated up to above 500 F, the mixer was shifted to a lower rotor speed to complete the crosslinking reaction. As shown in Table 2, an increased amount of silane masterbatch results in increased gel content, reduced compression set, reduced elongation at break, and a slight decrease in tensile stress and flexural modulus.

TABLE 2

| | Sample | Sample | Sample | Sample | Sample |
|---|---|---|---|---|---|
| | 1 | 2 | 3 | 4 | 5 |
| Composition | | | | | |
| Escorene ™ PP 1105 | 30 | 30 | 30 | 30 | 30 |
| EXACT ™ 8201 | 70 | 70 | 70 | 70 | 70 |
| Silane Masterbatch | 1.5 | 2 | 2.5 | 3 | 3.5 |
| Epsom Salt | 0.2 | 0.2 | 0.2 | 0.2 | 0.2 |
| Property | | | | | |
| Hardness, Shore D | | | | | |
| @ 0 sec Elapsed | 47 | 47 | 49 | 49 | 48 |
| Time | | | | | |
| @ 15 sec Elapsed | 43 | 43 | 44 | 44 | 42 |
| Time | | | | | |
| Tensile Stress, psi | | | | | |
| 100% Modulus | 1337 | 1272 | 1267 | 1165 | 1187 |
| 200% Modulus | 1464 | 1421 | 1445 | 1324 | 1375 |
| 300% Modulus | 1556 | 1548 | 1598 | 1472 | 1549 |
| Ultimate | 2497 | 2297 | 2207 | 2322 | 2293 |
| Ultimate Elongation, % | 1167 | 832 | 665 | 742 | 663 |
| Flexural Modulus, psi | | | | | |
| Tangent | 19804 | 19163 | 16369 | 15791 | 15257 |
| 1% Secant | 19308 | 18561 | 15994 | 15360 | 14840 |
| Tear Strength, lbs/in | | | | | |
| @ Max Load | 484.4 | 418 | 364.8 | 341.7 | 348.8 |
| @ Break | 241 | 249.5 | 214.6 | 173.6 | 248.9 |
| Compression Set, % | | | | | |
| @ 70 C. & 22 hrs | 83 | 77 | 74 | 70 | 72 |
| Xylene Extractables, % | 31.97 | 46.24 | 50.3 | 59.77 | 59.82 |

### Example 2

Samples 6-11 of Table 3 illustrate thermoplastic vulcanizates having a propylene homopolymer matrix phase and an ethylene based copolymer rubber phase produced by a continuous mixer, as described in detail below. The same resin mixture of Escorene™ PP 1105/Exact™ 8201 as described in Example 1, together with the silane masterbatch is first melt compounded using a 30 mm ZSK twin screw extruder to complete the silane grafting reaction. In a second pass, the melt blended compound together with Epsom salt was compounded on the same ZSK extruder to complete the crosslinking reaction. The same trends of silane addition on properties are observed as in Table 2.

TABLE 3

| | Sample | Sample | Sample | Sample | Sample | Sample |
|---|---|---|---|---|---|---|
| | 6 | 7 | 8 | 9 | 10 | 11 |
| Composition | | | | | | |
| Escorene ™ PP | 30 | 30 | 30 | 30 | 30 | 30 |
| 1105 | | | | | | |
| Exact ™ 8201 | 70 | 70 | 70 | 70 | 70 | 70 |
| Silane | 2 | 2.5 | 3 | 3.5 | 4 | 4.5 |
| Masterbatch | | | | | | |
| Epsom Salt | 0.2 | 0.2 | 0.2 | 0.2 | 0.2 | 0.2 |
| Property | | | | | | |
| Hardness, | | | | | | |
| Shore D | | | | | | |
| @ 0 sec | 47 | 46 | 46 | 45 | 47 | 46 |
| Elapsed Time | | | | | | |
| @ 15 sec | 42 | 41 | 42 | 40 | 42 | 40 |
| Elapsed Time | | | | | | |
| Tensile Stress, | | | | | | |
| psi | | | | | | |
| 100% Modulus | 1267 | 1180 | 1221 | 1190 | 1224 | 1248 |
| 200% Modulus | 1387 | 1325 | 1395 | 1460 | 1497 | 1545 |
| 300% Modulus | 1477 | 1448 | 1542 | 1698 | 1674 | 1751 |
| Ultimate | 2500 | 2400 | 2462 | 1766 | 1870 | 1893 |
| Ultimate | 1142 | 923 | 879 | 345 | 369 | 346 |
| Elongation, % | | | | | | |
| Flexural | | | | | | |
| Modulus, psi | | | | | | |
| Tangent | 18466 | 17703 | 16547 | 15701 | 15725 | 15383 |
| 1% Secant | 18442 | 17501 | 16523 | 15310 | 15482 | 15222 |
| Tear Strength, | | | | | | |
| lbs/in | | | | | | |
| @ Max Load | 444 | 397 | 392 | 356 | 349 | 342 |
| @ Break | 265 | 216 | 218 | 217 | 224 | 202 |
| Compression | | | | | | |
| Set, % | | | | | | |
| @ 70 C. & | 80 | 78 | 72 | 76 | 66 | 66 |
| 22 hrs | | | | | | |
| Vicat Softening | | | | | | |
| Point | | | | | | |
| @ 1000 g | 74.9 | 75.3 | 75.8 | 86.4 | 86.8 | 97.1 |
| Xylene | 39.12 | 52.62 | 54.24 | 63.83 | 64.56 | 65.4 |
| Extractables, % | | | | | | |

### Example 3

Samples 12-17 of Table 4 illustrate TPV compositions having a propylene homopolymer matrix phase, and a rubber phase comprising a combination of a metallocene plastomer and a low crystallinity EPDM rubber. Each of these compositions shows only a polypropylene melting peak by DSC, and no secondary low temperature peak was observed. Also in Sample 14 the Burgess clay served as both a moisture generation agent and a reinforcing agent as indicated by the higher tensile strength of the non-clay containing compounds.

TABLE 4

| Composition | Sample 12 | Sample 13 | Sample 14 | Sample 15 | Sample 16 | Sample 17 |
|---|---|---|---|---|---|---|
| Escorene ™ PP | 30 | 30 | 30 | 30 | 30 | 30 |
| 1105 | | | | | | |
| Exact ™ 8201 | 23 | | 23 | | 23 | |
| Vistalon ™ 3666 | 47 | 70 | | | | |
| Vistalon ™ 7500 | | | 47 | 70 | | |
| Vistalon ™ | | | | | 47 | 70 |
| 9303H | | | | | | |
| Silane | 3.4 | 3.4 | 3.4 | 3.4 | 3.4 | 3.4 |
| Masterbatch | | | | | | |
| Sunpar 150 HT | | | 10 | 10 | 10 | 10 |
| Epsom Salt | 0.2 | 0.2 | 0.2 | 0.2 | 0.2 | 0.2 |
| Burgess Clay 210 | | | 3.5 | | | |
| Property | | | | | | |
| Hardness, Shore | 79 | 78 | 78 | 71 | 78 | 74 |
| A @15 sec. | | | | | | |
| Ultimate Tensile, | 857 | 579 | 1065 | 486 | 831 | 602 |
| psi | | | | | | |
| Elongation at | 316 | 321 | 745 | 206 | 622 | 410 |
| Break | | | | | | |

### Example 4

Samples 18-20 of Table 5 illustrate TPV compositions having a propylene homopolymer matrix phase, and a rubber phase comprising a combination of metallocene plastomer and a high crystallinity EPDM rubber. As shown in Table 5, the substitution of a high crystallinity EPDM such as Vistalon 1703P (78 wt % ethylene and 36.5 J/g heat of fusion) for EXACT™ 8201 in this embodiment improves the softness (flexural modulus and hardness) of the TPV. Based on the gel content results, it is apparent that vinylsaline can be simultaneously grafted to both EXACT™ 8201 and Vistalon™ 1703P and crosslinked by the same type and amount of moisture generating agent, (Epsom salt).

TABLE 5

| | Sample 18 | Sample 19 | Sample 20 |
|---|---|---|---|
| Composition | | | |
| Escorene ™ PP 1105 | 29.1 | 29.1 | 29.1 |
| Exact ™ 8201 | 68 | 48 | 38 |
| Vistalon ™ 1703P | | 20 | 30 |
| Silane Masterbatch | 2.9 | 2.9 | 2.9 |
| Epsom Salt | 0.2 | 0.2 | 0.2 |
| Sunpar 150HT | 5 | 5 | 5 |
| Property | | | |
| Melt Flow Rate @ 10X, dg/min | 2.9 | 4.2 | 8 |
| Shore D Hardness | 48.4 | 45.2 | 42.2 |
| Ultimate Tensile Stress, psi | 1980 | 1785 | 1527 |
| Elongation @ Break, % | 434 | 448 | 410 |
| Tensile Modulus, psi | | | |
| 15% | 330 | 367 | 268 |
| 100% | 1263 | 1125 | 1005 |
| 200% | 1528 | 1354 | 1220 |
| 300% | 1741 | 1542 | 1388 |
| Flexural Modulus-1% Secant, | 16855 | 14606 | 12584 |
| psi | | | |
| Tear Resistance, lbf/in | | | |
| @ Max Load | 359 | 363 | 319 |
| @ Break | 213 | 211 | 183 |
| Compression Set, RT & 22 hr, | 42.4 | 44 | 45.1 |
| % | | | |
| Xylene Insolubles, % | 58.65 | 53.51 | 47.57 |

All compositions shown in Table 5 were produced by two pass compounding using a 30 mm ZSK twin screw extruder. All ingredients were first blended together and fed into the extruder to complete the silane grafting reaction. In a second pass extrusion, Epsom salt was compounded together with the materials produced from the first pass to complete the crosslinking reaction. Samples 19 and 20 show a decrease in stiffness (flexural modulus), as compared to comparative sample 18, as more Vistalon™ 17003 P is used to replace the stiffer Exact™ 8201.

### Example 5

TPV compositions were prepared with an impact modified polypropylene copolymer (Escorene™ PP 8191) as the matrix phase, and a rubber phase comprising a metallocene plastomer (Exact™ 4033) and a halogenated rubber (Exxpro™ 89-1), as shown in Table 6.

TABLE 6

| | Sample 21 | Sample 22 | Sample 23 |
|---|---|---|---|
| Composition | | | |
| Escorene ™ PP 8191 | 40 | 40 | 40 |
| Exact ™ 4033 | 55 | 55 | 47.5 |
| Exxpro ™ 89-1 | 5 | 5 | 12.5 |
| Zinc Oxide | | 0.05 | 0.2 |
| Zinc Stearate | | 0.05 | 0.2 |
| Property | | | |
| Melt Flow Rate @ wt, dg/min | 1 | 0.9 | 0.1 |
| Flexural Modulus, 1% secant, psi | 23900 | 22000 | 20500 |

In the presence of zinc oxide and zinc stearate, the plastomer can be grafted onto the halogenated rubber. But the combination of zinc oxide/zinc stearate is ineffective in crosslinking the plastomer, itself. The extra amount of zinc oxide and zinc stearate present can be used to crosslink the halogenated rubber. Sample 21 shows that by substituting 5 parts of the halogenated rubber for the plastomer, the resulting blend has a melt flow rate of 1 dg/min. Sample 22 is identical to Sample 21, except that 0.05 parts of zinc oxide per hundred parts of resin and 0.05 parts of zinc stearate per hundred parts resin were added. The resultant composition showed a slight decrease of melt flow rate due to crosslinking of the 5 parts of halogenated rubber. In Sample 23, 12.5 parts of the halogenated rubber was used to replace an equal amount of the plastomer, and the melt flow rate decreased to 0.1 dg/min, indicating an increased degree of crosslinking in the compound.

While the present invention has been described in considerable detail with reference to certain preferred versions thereof, other versions are possible. Also, different types of members and configurations of members can be formed in accordance with the invention, in a number of different ways that will be apparent to persons having ordinary skill in the art. Therefore, the spirit and scope of the appended claims should not be limited to the description of the preferred versions contained herein.

All documents cited herein are fully incorporated by reference for all jurisdictions in which such incorporation is permitted and to the extent they are not inconsistent with this specification. All documents to which priority is claimed are fully incorporated by reference for all jurisdictions in which such incorporation is permitted. Although dependent claims have single dependencies in accordance with U.S. practice, each of the features in any of the dependent claims can be combined with each of the features of one or more of the other dependent claims dependent upon the same independent claim or claims.

1) A run-flat tire insert comprising a thermoplastic vulcanizate.

2) The run-flat tire insert of claim 1, wherein said thermoplastic vulcanizate comprises a thermoplastic matrix phase and an at least partially cross-linked rubber phase.

3) The run-flat tire insert of claim 2, wherein the matrix phase comprises about 15 to about 80 parts by weight and the rubber phase comprises about 20 to 85 parts by weight per 100 parts by weight of the thermoplastic vulcanizate.

4) The run-flat tire insert of claim 2, wherein said thermoplastic matrix phase comprises at least one of a polyolefin, a polyamide and a polyester.

5) The run-flat tire insert of claim 4, wherein said polyolefin comprises at least one of a polyethylene, a polypropylene, a polyethylene copolymer, and a polypropylene copolymer.

6) The run-flat tire insert of claim 2, wherein the thermoplastic matrix phase comprises a blend of a polypropylene component and an uncrosslinked elastomeric rubber component.

7) The run-flat tire insert of claim 6, wherein said uncrosslinked elastomeric rubber component comprises less than 20 wt % of said blend.

8) The run-flat tire insert of claim 6, wherein said polypropylene component is a polypropylene homopolymer having a molecular weight of at least 70,000.

9) The run-flat tire insert of claim 4, wherein said polyamide has a melting point of between 160° C. and 275° C.

10) The run-flat tire insert of claim 4, wherein said polyamide comprises nylon.

11) The run-flat tire insert of claim 10, wherein said nylon is selected from at least one of polycaprolactam (nylon 6), polylaurylactam (nylon 12), polyhexamethyleneadipamide (nylon 6,6), polyhexamethylene-azelamide (nylon 6,9), polyhexamethylenesebacamide (nylon 6,10), polyhexamethyleneisophthalamide (nylon 6,IP) the condensation product of 11-aminoundecanoic acid (nylon 11) and partially aromatic polyamides made by polycondensation of meta xylene diamine and adipic acid.

12) The run-flat tire insert of claim 2, wherein the at least partially cross-linked rubber phase comprises at least one of halobutyl rubber, ethylene-propylene rubber, ethylene-propylene-diene terpolymer rubber, natural rubber, synthetic rubber, amine functionalized synthetic rubber, and epoxy functionalized synthetic rubber.

13) The run-flat tire insert of claim 2, wherein the at least partially cross-linked rubber phase comprises an ethylene copolymer, having about 85 mol % to about 96 mol % ethylene units, about 4 mol % to about 15 mol % alpha-olefin units, a density from about 0.915 g/cm³ to about 0.860 g/cm³, and a CDBI of greater than 60.

14) The run-flat tire insert of claim 13, wherein said ethylene copolymer is characterized by a single melting point peak in the region of 50° C. to 110° C. as measured by DSC (second melt rundown).

15) The run-flat tire insert of claim 13, wherein said ethylene copolymer has a weight average molecular value of between 70,000 and 130,000.

16) The run-flat tire insert of claim 13, wherein said ethylene copolymer has a 1% secant modulus less than 15,000.

17) The run-flat tire insert of claim 2, wherein the at least partially cross-linked rubber phase comprises an ethylene copolymer and an ethylene-propylene-diene terpolymer, said ethylene copolymer having about 85 mol % to about 96 mol % ethylene units and about 4 mol % to about 15 mol % alpha-olefin units.

18) The run-flat tire insert of claim 17, wherein said at least partially cross-linked rubber phase comprises from about 25 wt % to about 50 wt % of said ethylene copolymer and about 50 wt % to about 75 wt % of a low crystallinity ethylene-propylene-diene terpolymer.

19) The run-flat tire insert of claim 17, wherein said at least partially cross-linked rubber phase comprises from about 40 wt % to about 80 wt/o of said ethylene copolymer and about 20 wt % to about 60 wt % of a high crystallinity ethylene-propylene-diene terpolymer.

20) The run-flat tire insert of claim 2, wherein the at least partially cross-linked rubber phase comprises (a) about 25 Wt/o to about 50 wt % of an ethylene copolymer having about 85 mol % to about 96 mol % ethylene units and about 4 mol % to about 15 mol % alpha-olefin units, and (b) about 50 wt % to about 75 wt % of a halogenated copolymer of a C₄ to C₇ isomonoolefin and an alkylstyrene.

21) The run-flat tire insert of claim 20, wherein said halogenated copolymer comprises about 0.5 wt % to about 50 wt % alkylstyrene units.

22) The run-flat tire insert of claim 20, wherein said halogenated copolymer comprises halogen units of from about 0.1 wt % to about 7.5 wt %.

23) The run-flat tire insert of claim 20, wherein said halogenated copolymer has a Mooney viscosity at 125° C. (ML 1+8) of from about 20 to about 55.

24) The run-flat tire insert of claim 20, wherein said isomonoolefin comprises isobutene.

25) The run-flat tire insert of claim 20, wherein said alkylstyrene comprises halogenated methylstyrene.

26) The run-flat tire insert of claim 20, wherein said halogen is bromine.

27) A run-flat tire insert comprising a thermoplastic vulcanizate having a propylene polymer matrix phase and ethylene based copolymer rubber phase.

28) The run-flat tire insert of claim 27, wherein said polypropylene polymer matrix phase comprises a polypropylene homopolymer having a molecular weight of at least 70,000.

29) The run-flat tire insert of claim 27, wherein said polypropylene polymer matrix phase comprises an impact copolymer.

30) The run-flat tire insert of claim 27, wherein the propylene polymer matrix phase comprises about 15 to about 80 parts by weight and the ethylene based copolymer rubber phase comprises about 20 to 85 parts by weight per 100 parts by weight of the thermoplastic vulcanizate.

31) The run-flat tire insert of claim 27, wherein the ethylene based copolymer rubber phase comprises an at least partially crosslinked copolymer having about 85 mol % to about 96 mol % ethylene units, about 4 mol % to about 15 mol % alpha-olefin units, a density from about 0.915 g/cm³ to about 0.860 g/cm³, and a CDBI of greater than 60.

32) A run-flat tire insert comprising a thermoplastic vulcanizate having a polyamide matrix phase and ethylene based copolymer rubber phase.

33) The run-flat tire insert of claim 32, wherein said polyamide has a melting point of between 160° C. and 275° C.

34) The run-flat tire insert of claim 32, wherein said polyamide comprises nylon.

35) The run-flat tire insert of claim 34, wherein said nylon is selected from at least one of polycaprolactam (nylon 6), polylaurylactam (nylon 12), polyhexamethyleneadipamide (nylon 6,6), polyhexamethylene-azelamide (nylon 6,9), polyhexamethylenesebacamide (nylon 6,10), polyhexamethyleneisophthalamide (nylon 6,IP) the condensation product of 11-aminoundecanoic acid (nylon 11) and partially aromatic polyamides made by polycondensation of meta xylene diamine and adipic acid.

36) The run-flat tire insert of claim 32, wherein the ethylene based copolymer rubber phase comprises an at least partially crosslinked copolymer having about 85 mol % to about 96 mol % ethylene units, about 4 mol % to about 15 mol % alpha-olefin units, a density from about 0.915 g/cm³ to about 0.860 g/cm³, and a CDBI of greater than 60.

37) A run-flat tire insert comprising a thermoplastic vulcanizate having a polypropylene homopolymer matrix phase and an at least partially crosslinked rubber phase comprising an ethylene copolymer having about 85 mol % to about 96 mol % ethylene units, about 4 mol % to about 15 mol % alpha-olefin units, a density from about 0.915 g/cm³ to about 0.860 g/cm³, and a CDBI of greater than 60.

38) The run-flat tire insert of claim 37, wherein said alpha-olefin units comprise octene units.

39) The run-flat tire insert of claim 37, wherein said alpha-olefin units comprise butene units

40) The run-flat tire insert of claim 37, wherein said alpha-olefin units comprise hexene units.

41) A run-flat tire insert comprising a thermoplastic vulcanizate having a polypropylene homopolymer matrix phase and a rubber phase comprising (a) an at least partially crosslinked ethylene copolymer having about 85 mol % to about 96 mol % ethylene units, about 4 mol % to about 15 mol % alpha-olefin units, a density from about 0.915 g/cm³ to about 0.860 g/cm³, and a CDBI of greater than 60, and (b) an ethylene-propylene-diene terpolymer.

42) The run-flat tire insert of claim 41, wherein said ethylene-propylene-diene terpolymer has a heat of fusion less than 10 J/g.

43) The run-flat tire insert of claim 41, wherein said ethylene-propylene-diene terpolymer has an ethylene content of greater than 70 wt % and a heat of fusion more than 10 J/g.

44) A thermoplastic vulcanizate comprising a polypropylene homopolymer matrix phase and a rubber phase comprising (a) about 25 wt % to about 50 wt % of an at least partially crosslinked ethylene copolymer having about 85 mol % to about 96 mol % ethylene units, about 4 mol % to about 15 mol % alpha-olefin units, a density from about 0.915 g/cm³ to about 0.860 g/cm³, and a CDBI of greater than 60, and (b) about 50 wt % to about 75 wt % of a low crystallinity ethylene-propylene-diene terpolymer having a heat of fusion less than 10 J/g.
